(19) United States
(12) Patent Application Publication
(10) Pub. No.: US 2015/0195765 A1
(43) Pub. Date: Jul. 9, 2015

(54) Method, Apparatus and System for Connected Automobiles

(71) Applicant: Sanjay Bhardwaj, Fremont, CA (US)

(72) Inventor: Sanjay Bhardwaj, Fremont, CA (US)

(21) Appl. No.: 14/658,169

(22) Filed: Mar. 14, 2015

Related U.S. Application Data
(60) Provisional application No. 61/970,204, filed on Mar. 25, 2014.

(51) Int. Cl. H04W 40/02

(52) U.S. Cl. CPC H04W 40/02; H04W 84/12

(57) ABSTRACT

An integrated device for connected cars that provides a plurality of standard and new interfaces, which is implemented in flexible hardware to overcome the mismatch between an automobile lifetime and cellular and semiconductor technology development. By providing interfaces in one device, greater synergy of applications is possible. Integration of the on board diagnostics with the infotainment device is a function enabler for the automobile ecosystem. The present invention is open to integration with the car electronic driver assistance and evolving autonomous driver modules, providing additional economies of scale.

### BENEFIT OF EARLIER FILING DATE FOR PRIORITY

This non-provisional patent application claims benefit of priority date through specific reference to provisional patent application No. 61/970,204 dated Mar. 25, 2014 under 35 U.S.C. 119 (e)(1). See also 37 C.F.R. 1.78.

### FIELD OF THE INVENTION

The present invention relates generally to car electronics More specifically, the present invention is an automobile integrated device (AID) is proposed which provides intra-car and inter-car connectivity for data, media, and vehicle to vehicle and on board diagnostics. The hardware is flexible with capability to be upgraded over the air.

### BACKGROUND OF THE INVENTION

An automobile is the third most desired object to be connected to the internet. Presently, there is almost in total reliance on the cell phone to provide internet connectivity to the car. However, due to increased demand for applications like video on demand, to be available in cars, a cell phone connection, even though matching in bandwidth will not be viable. The mobility of the cell phone has its negative aspects that the cell phone may be lost, stolen or forgotten at home. Such occurrences, though rarely, do occur and will lead to disruption of services in the car. It is also foreseeable that the services provided in the car will support critical needs whose loss is not desirable. In that sense, it is an added value proposition that a connected device be and remain attached with the car.

Also, the present art of car electronics is such that a number of small individual devices are available in a piece by piece way. There is no single comprehensible device that once provided in the car or installed thereto, would provide connectivity within the car as a single total solution. Such an integrated total solution is more valuable in the car as the cabin space is premium and a number of devices in a small cube space cause or appears to cause chaos and disorder with slight displacement. Too many devices, without central integration also lead to a number of wires between devices and from the devices to hard installed car electronics. Accordingly, a single device offering standard input/output connections along with new and next generation interface to provide connectivity between all radios in a car adds substantial value in economics, comfort and quality of driving experience for the car owner and his companions.

### BRIEF DESCRIPTION OF THE DRAWINGS

FIG. 1 is one embodiment of a system on chip showing the embedded processor, memory, input and output blocks and other system components with space and logic gates for possible inclusion of a plurality of radios.

FIG. 2 is one embodiment of a semiconductor component which incorporates a system on chip with processor, memory I/O and peripherals connected with a plurality of buses. The new radios and components are added for transforming the system on chip in an automobile integrated device.

FIG. 3 is an embodiment of the top level system diagram, comprising of enumerated system components and new radios incorporated.

FIG. 4 is one embodiment in an exemplary way of the media distribution function that the device will involve. The connection to the cloud will be over the cell phone from where the information will be transmitted or received. The same information after electronic processing will be disseminated over the WIFI, Bluetooth and wired connection for use in and around the automobile. To complete the connection, where the connection is bidirectional, information will be sent from the in and around automobile towards the cellular. The operations will occur, where required under the supervision of a processor.

FIG. 5 is an exemplary embodiment of the on board diagnostics use. The on board diagnostics (OBD) port, in one embodiment connects to the device for to and from information exchange with the automobile. This information will be conveyed on the dashboard through wired and wireless connections. In another embodiment, the information will be sent over the cell phone. Status will be conveyed from OBD port to cellular connection or the dashboard, while commands will be placed from the cellular connection or the dashboard towards the OBD.

FIG. 6 is an exemplary embodiment of the vehicle to vehicle and vehicle to infrastructure communication. In one exemplary embodiment, the information from the digital short range communication based vehicle information is displayed and played in the car. In another exemplary embodiment, the information is conveyed to and from the WIFI network and the cellular network, transforming a vehicle area network into a local area network and/or a wide area network over the cellular data pipe.

FIG. 7 is an exemplary embodiment of the global positioning system where the information is displayed and played with the automobile system and also relayed over the WIFI network. The application may, in one embodiment operate under the main processor or its own embedded processor.

FIG. 8 is an exemplary embodiment of the automobile Ethernet interface over which automobile related information is exchanged in both directions. This interface also presents another way in the future to connect to the in car installed electronics for driver assistance and media.

FIG. 9 is an exemplary embodiment of the cellular data pipe implementation from the receipt and transmission of information from the antenna to digital conversion, extraction of radio packets. Digitized modulator and demodulator functions.

### DETAIL DESCRIPTIONS OF THE INVENTION

All illustrations of the drawings are for the purpose of describing selected versions of the present invention and are not intended to limit the scope of the present invention.

In the following description specific details are set forth describing certain embodiments. It will be apparent, however, to one skilled in the art that the disclosed embodiments may be practiced without some or these entire specific details. The specific embodiments presented are meant to be illustrative, but not limiting. One skilled in the art may realize other material that, although not specifically described herein, is within the scope and spirit of this disclosure.

The present invention is targeted towards automobiles. The present invention provides a cellular data pipe into the car through a fixed installed device. The present invention supports connection to the car's on-board diagnostic port. This port is a standard and a requirement on all cars. A connection to the OBD port supports all applications related to a car's repair, maintenance and diagnostics. Through additional application interfaces, support may be augmented to be able to remote lock/open the car, control the windows, defrost and climate control. The odometer, tire pressure, oil age, oil level and other maintenance related parameters could be tracked. The present invention makes available the OBD related information over the cellular data pipe for remote monitoring and actions. Also, the present invention makes available the same information to the driver through a Bluetooth or other connection to the car, including a wired connection or a WIFI.

Besides the OBD function, the cellular data pipe will be the main cloud connection of the car for internet access. This enables access to social media, audio and video applications from the cloud to the car driver and its passengers. Existing audio, video and data applications are available in the car. The present invention provides a router function to enable 5-8 WIFI connections for the car users. The present invention provides a fixed Ethernet connection at 1 Gbps, 100 Mbps and 10 Mbps speeds inside the car. The WIFI also provides yet another mechanism to connect to the car entertainment system for audio and video streaming.

With the present invention, applications will be enabled to access the home network from anywhere when travelling. The home network devices, the fixed PC and the files are accessible from the car, along with a cellular connection to the video/audio pipe of the home cable modem or the dish receiver. The entire programming is available from the car as well as in a hotel where the car is parked, be it the user owned car or the rented car. Appropriate strength of the WIFI hot spot and parking of the car enables internet access to the hotel room, hotel lobby and hotel data center or office to avoid another payment of connection. Similarly, where the present invention is installed in vehicle used for camping, the internet is available in all areas where a cellular service is available.

The presence of a cellular connection also supports a vehicle to vehicle communication under the IEEE 802.11p standard. This application is geared towards driver safety for driving under fog, rain or at nighttime, where information with upstream drivers could be shared for proper and timely action. The present invention also has requisite blocks for the support for GPS. Proper accelerometer and gyroscope hardware and software is integrated in the present invention.

Currently, in the connected car space, the connected car model is projected in three ways. The integrated model relies on the cell phone for everything except display and audio playing. In the tethered model, the cell phone provides internet connection, but separate infotainment hardware is provided. In the third model, hardware device similar to one described is hard installed in the car and is stated to be embedded hardware to support the function. A cell phone is not needed. The user is free from tying the cell phone to the car. It is projected that the connected cars will move towards an embedded model eventually with proliferation of services and cost reductions due to technology advancements and economies of scale. The embedded model is vehicle centric, has high reliability and supports high availability applications. It is projected that by 2017, 16 million cars will have a 4G LTE connection.

Cellular technology is evolving at a rapid pace. The evolution in the technology is signified by the indication of a generation, for example 2G is the second generation of the technology which brought digital technology to the cell phones. The 2G technology involves, among others, GPRS technology spanning bandwidth from 140 to 474 kilobits per second and recently encompassed about 70% of the global connections. The 3G technology spans a speed of 384 kilobits per second to 14.4 megabits per second and comprises about 20% of global connections. The 4G technology which develops on high speed packet architecture spans bandwidths of about 170 megabits per second. It is projected that by 2017 a substantial number of cars will have 4G LTE connection.

The development cycle for an automobile is 24 to 36 months and the lifetime of products is 7 to 10 years. The cycles in the mobile network operator space are much shorter and frequently prone to changes. Therefore, viewing the car as a “field,” ability to provide upgradability of the hardware and feature set of components over the air carries tremendous value to the car industry, for the owners, dealers and car owners alike. Piecewise upgrade is possible for the processor, for the WIFI, for the GPS, for the Bluetooth and for the V2V through on air provisions. In one embodiment, various pieces of the configurable hardware could be upgraded by themselves. With connection to cloud available, the respective plurality of images could be placed over a customer service website data and through customer's choice of time and function, the configurable hardware could be chosen to be upgraded. Support in hardware only, software only or in a mixed embodiment of hardware and software could be provided for such upgrade over the air.

One barrier to entry of the cellular technology is the cost of incorporating the radio and its components in silicon. The 2G cost of $20 has accounted for the depreciation over time, but the 4G cost is expected to reduce 10% a year for some years beyond 2015 due to maturity in technology and economies of scale. In one embodiment, the present invention's killer application is video on demand inside the car. Since the generation of higher bandwidth services tends to complement rather than supplement the lower bandwidth services, there is no reason to believe that the 4G LTE services to the car will not saturate down to 2G prices.

The core of the integrated connected device is configurable hardware with a system on chip, extensible memory and—it provides raw gates to be able to integrate a plurality of hardware including a plurality of radios. The configurable hardware's power dissipation is projected to be low enough to allow the device to operate without fans, which is a necessity almost, in the present application. Use of the configurable hardware for the final design allows continual design tweaks to be made after the PCBs have been manufactured and fielded in. With evolving cellular technology, it is a huge advantage to be able to change on the field over the air without a “pit stop.” In another embodiment, the use of application specific integrated circuit can be considered though the use of application specific integrated circuit involves huge up-front cost and it would not be nearly so easy to change the design to accommodate standards and design/feature set improvements. The use of the processor based system on chip within the configurable hardware provides advantage in terms of bill of materials costs and low power dissipation. In another embodiment, based on the proof of prototype and cost analysis, an application specific integrated circuit model can be considered with the option of integration of radios on the application specific integrated circuit itself. In another embodiment, the radio frequency chips for each of the radio could be external to the application specific integrated circuit.

The core of the design comprises of a processor with a plurality of cores, requisite instruction and data caches, second level cache, its controller, a plurality of DMA engines. The IP also has standard I/O integrated a plurality of Serial Peripheral Interface, Controller Area network, I2C, universal Asynchronous Receive and Transmit, general Purpose I/O, SDIO, Universal Serial Bus and Gigabit Ethernet. The processor may include a plurality of integer processors, floating point unit processors, digital signal processing processors and graphics processors.

The present invention also contains system on chip components to run environment of extraction of the data pipe traffic and distributing it from various interfaces in both directions. Based on the amount of the compute power available with the processors, embedded processor support will be sought by the cellular process, BlueTooth, WIFI based router, FM Tuner and GPS. In another embodiment, each of these blocks may have an embedded processor of their own. A communication mechanism may exist for each of the individual embedded processor to communicate with the main processor. In another embodiment, it is expected that processing support will be needed for GPS receiver, WIFI router with cellular data pipe as upstream with a plurality of wireless links support and one wired Ethernet link. In another embodiment, the algorithms associated with each of the above processing may be achieved by a dedicated set of hardware.

The system on chip provides on chip memory as well as extensible external DDR memory and support for external SPI of various configurations. This block will serve as the main data pipe block on the device with support for bandwidths from 144 Kbps to 170 Mbps. In one embodiment, the main application targeted is the video on demand application. Either through the use of a dedicated embedded processor or through partial help from the main processor, the cellular traffic will be extracted for voice, data and video, placed in system memory and outputted to various interfaces. Similarly, as required by the supported interfaces, the traffic will be collected from the interfaces and outputted towards the cellular data pipe. The connection of the cellular data pipe to the main processor interface would be possibly through a system bus interconnect to a DMA with appropriate hardware assistance in both directions.

In one embodiment, the integrated car connected device has an interface to receive GP signal, an interface to send and receive cellular signals, an automobile Ethernet connection to send and receive Ethernet packets from other devise in the car, a plurality of USB ports, Video output port, audio out and audio in port, a power source from car battery, a receive and transmit radio WIFI and a receive and transmit Bluetooth.

A cellular data pipe is integrated with configurable hardware. It is expected that the full function will be supported with a connection to external RADIO PHY and an antenna on the board. In one embodiment, the planned interface for the RADIO PHY is the JESD and for the packet side is CPRI (Common Public Radio Interface). In one embodiment, the cellular pipe will support all traffic speeds. In one embodiment, using 4G cellular technology, the maximum bandwidth projected is 170 Mbps.

LVDS (Low Voltage Differential Signaling), MOST (Media Oriented Systems Transport) and CAN (Controller Area Network) operate as islands today in cars. The addition of automobile Ethernet as an interface to receive and transmit information is based on the proposition that automotive Ethernet will become backbone of cars in the future. In one embodiment, the interface has been added with future development where the MOST or CAN busses may be complemented over this interface. In one embodiment, all communications from the car emanating from LVDS, CAN, or MOST bus are received and transmitted on this interface. The captured information from the car is made available to the cloud in one embodiment.

The present invention also supports digital short range communication standard and enable vehicle to vehicle communication in a circle of around 500 meters to about 2 miles. The function represents another communication mechanism where the network traffic is extracted by the block through a radio and passed in both directions to the embedded processor through DMA. It is then read and interpreted by appropriate interfaces, primarily for audio and outputted. Since the channel in the first application will be used primarily for audio, the bandwidth and compute requirements may be small.

The present invention will integrate the global positioning system function blocks. The function will have algorithmically developed accelerometers and gyroscope to position and track the vehicle and provide driving parameters. The function will have a radio only in the receive direction, with a corresponding Radio physical interface. Information will be extracted in the receive direction and passed as DMA traffic into system memory. The software related to the GPS function will read, process and extract information and provide a screen interface through HDMI or USB like port.

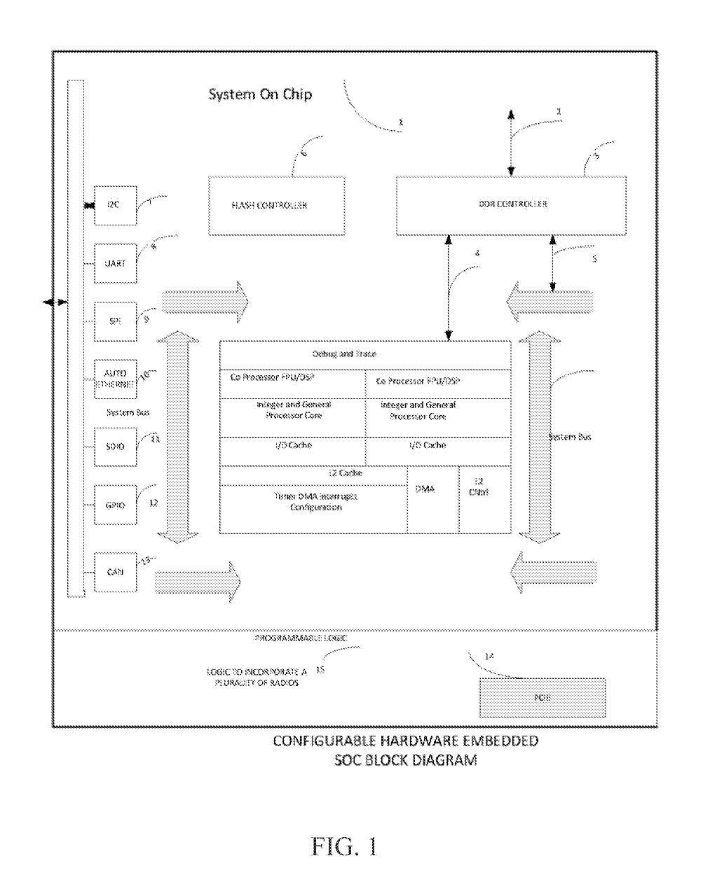

FIG. 1 illustrates a system on chip 1 component implemented in configurable hardware. An embedded processor 16 communicates with on chip 3 and external volatile memory through memory interface and external memory block 3. The same processor 16 communicates with retainable memory 6 through a controller 6 and external memory. It has a system bus 17 and a system peripheral bus, with a plurality of inputs and outputs 7, 8, 9, 10, 11, 12. In one embodiment, on chip first level and second level caches are present, along with their controllers 16. The system on chip presents opportunities in terms of resources and interfaces 15 to add a plurality of radios of various speeds and various ranges of reception and transmission. In one embodiment, the connection between any new interface and the system is designed to be modular.

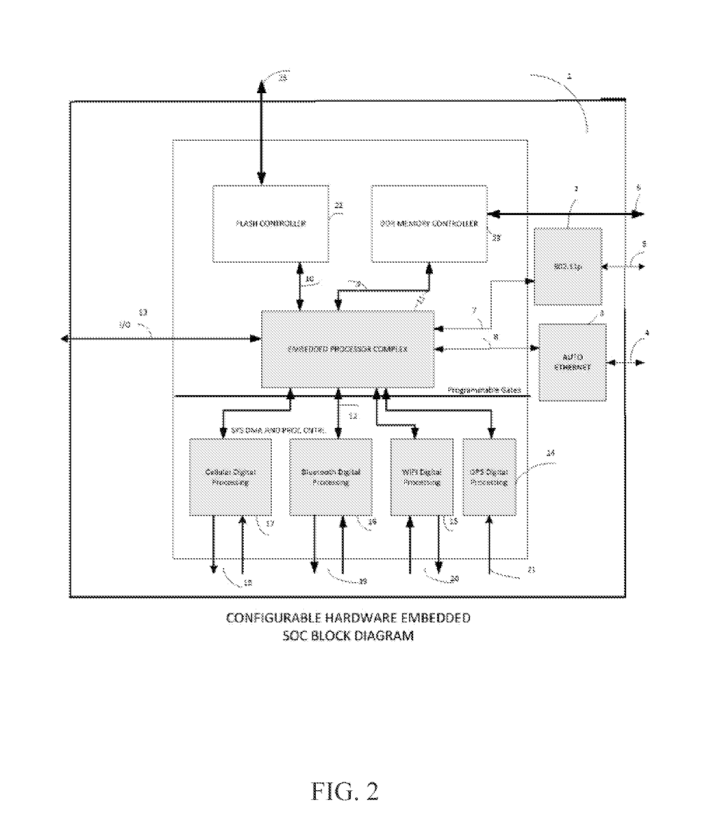

FIG. 2 illustrates the configurable hardware semiconductor component 1. In one embodiment, associated with a radio for cellular 17, for WIFI 15, Bluetooth 16, GPS 14, V2V 2, auto Ethernet 3, the physical and media and access control components are located on the semiconductor component and their interface with their radio chips over a plurality of interfaces 18, 19, 20, 21, 4, 5. The radio chips are located external to the semiconductor chip. In another embodiment, the hardware could be non-configurable application specific integrated circuit. In another embodiment, a plurality of radio RF chips could be inside the configurable hardware and a plurality of RF chips could be external to it. In one embodiment, the configurable hardware semiconductor component comprises of a processor 11, retainable memory 22, 25 and volatile system memory 23, 6, system bus, system peripheral bus 13 and a plurality of DMA engines, computer peripherals and their interfaces. The semiconductor component has an automobile Ethernet connection through block and interface 3, 4. In another embodiment, to optimize or perform trade off on other system aspects, the single semiconductor device may be made to comprise of a plurality of discrete chips, each either configurable or application specific.

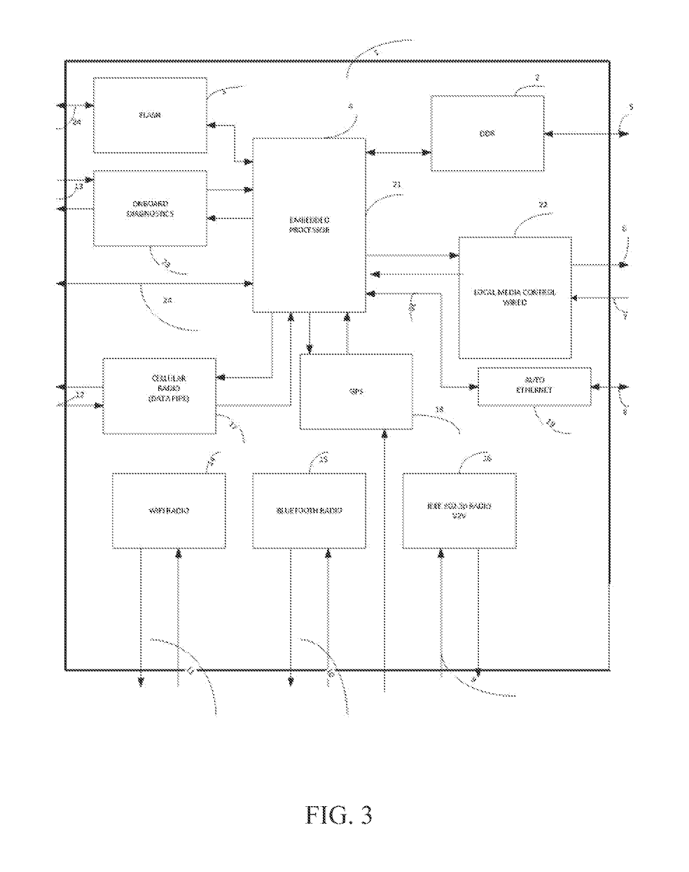

A system level diagram 1 is shown in FIG. 3. It comprises an embedded processor 21 connected to system memory and its controller 2, 3 and flash memory and its controller 3, 24. As a typical system, an embodiment presents a plurality of wired media connections in both directions which operate under the embedded processor 6, 7, 22. Embedded processor 21 also connects to a plurality of input output interfaces, including but not restricted to I2C, SPI, USB, UART, SDIO, Ethernet of various speeds 24. The embedded processor 21 in one embodiment controls the on board diagnostics 23 port 13. The OBD 23 interface 13 in one embodiment is implemented though a controller area network bus. In another embodiment any of the four other protocols could be supported. The system interfaces with a cellular data pipe with interface 12 and block 17. In one embodiment, receive and transmit blocks operate fully in hardware. In another embodiment, some portion of receive and/or transmit components could be implemented using the embedded processor. The cellular block 17 takes data to and from the cellular towards the system memory through a plurality of DMA controllers. Under software and hardware control, in one embodiment, the information so received is passed over the various interfaces including but restricted to the Bluetooth interface 10, the WIFI interface 11, the V2V interface 9 or the wired interface 6, 7. Similarly, the information received over any of the interfaces with appropriate processing is transmitted over the cellular pipe 12.

In one embodiment, this cellular data pipe 17 interplay with the rest of the system is repeated for modular components and through modular mechanisms where each of the interfaces could be independently added or removed. The interplay of the cellular pipe is repeated for WIFI block and its interface (LAN), for Bluetooth and its interface, for V2V and its interface, for automobile Ethernet and its interface 14, 15, 16, 19. The same interplay is also repeated for GPS 18, except that it only has a receive pipe from its radio. The above arrangement is exemplary. In another embodiment, the implementation may remove any of the plurality of radios and add any plurality of radios.

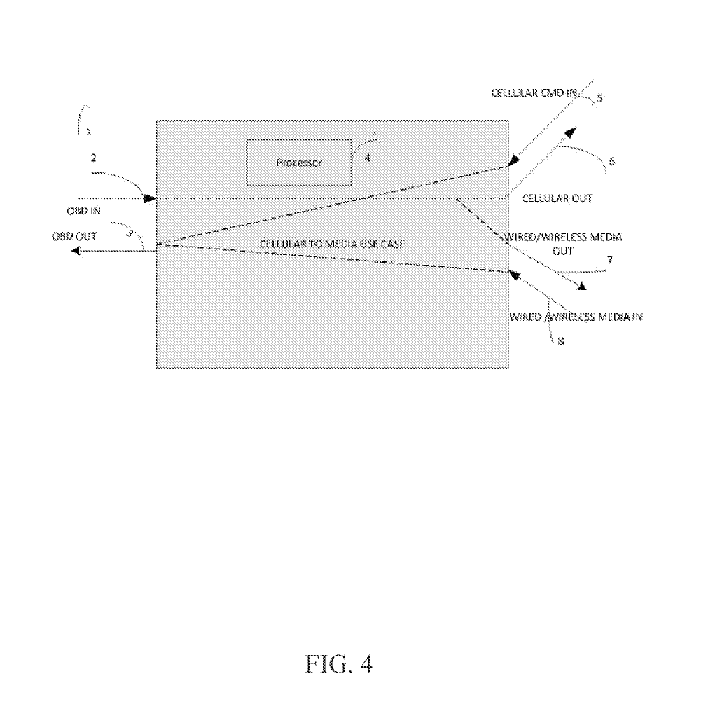

FIG. 4 illustrates the main cellular pipe use case. The information comes over the cellular 5 and under the processor 4, is passed as necessary to either the on board diagnostics port 3, the wired media port 7, wireless media ports 7,8. Similarly, information is collected from either of the interfaces of OBD 2, wireless media 7, 8, wired media and passed over to cloud over the transmit port of the cellular 3. The presence of this plurality of interfaces adds to the functions and variety of communications not possible in a plurality of discrete devices.

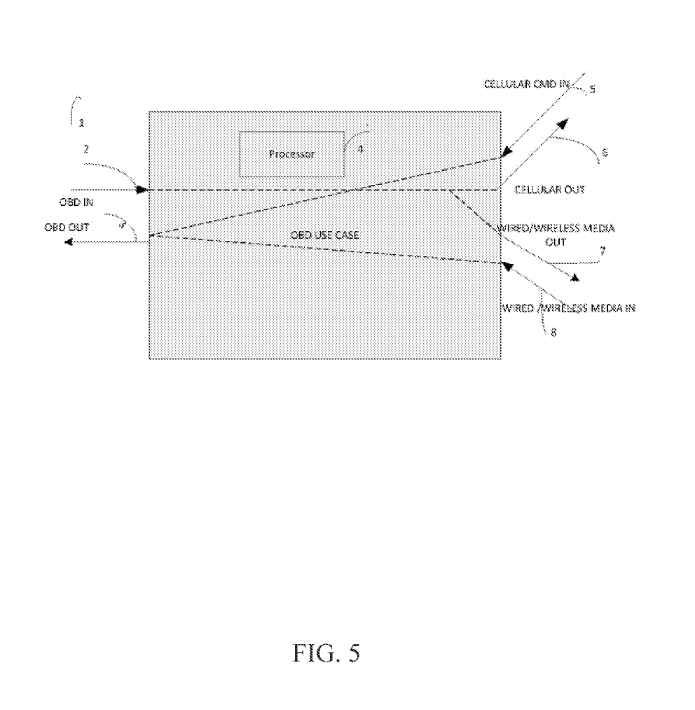

FIG. 5 illustrates the on board diagnostics use case 1. With the help of the present invention, the OBD provided information 2 can be made available to the cloud through the cellular pipe 6. It can also be made available over the wired media and wireless media connections 7, 8. This makes the car owner a first cut diagnose of his car problem, making him a strong bargainer. The commands conveyed over the cellular connection or dashboard, under proper software or hardware support are send on the OBD out port to be executed over the automobile 6.

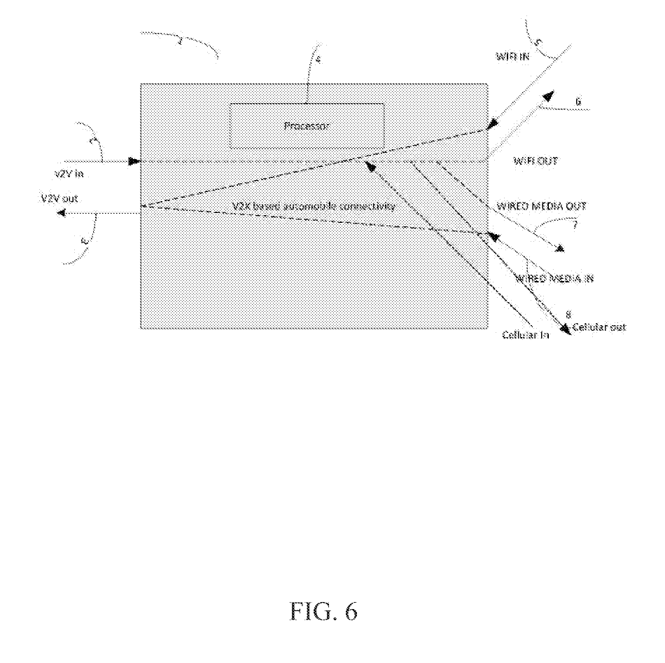

FIG. 6 is an illustration of the various possibilities of communication with the integration of V2V interface 1. As a basis level, the received information could be processed and transmitted over V2V itself 2, 3. The present invention also has capability to switch V2V information over the wired local, wireless local and cellular in both directions 5, 6, 7, 8. The directions and interfaces are illustrated. The integration is an enabler for converting a digital short range communication to a LAN and WAN network with the help of the present invention, in one of its embodiment 1.

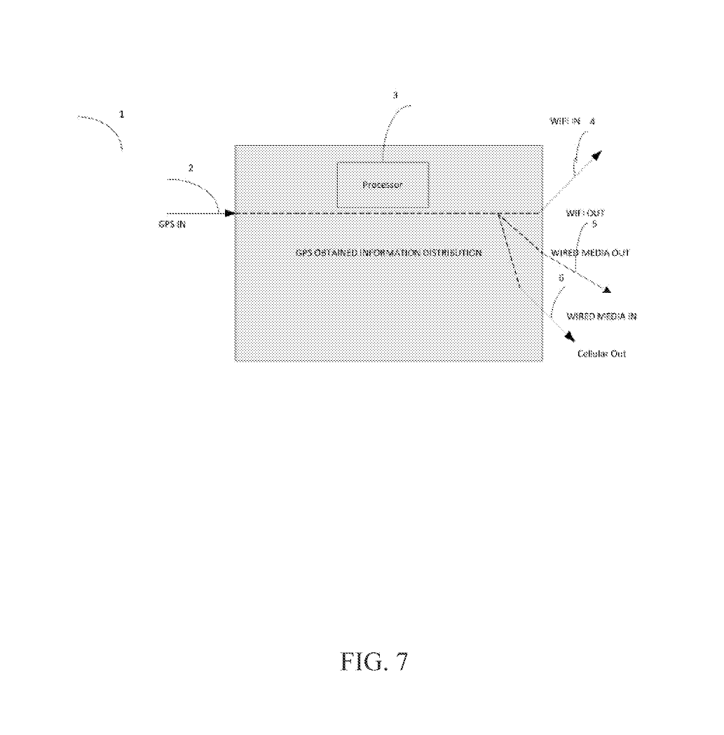

FIG. 7 illustrates the global positioning system use case 1. Its integration in the device enables communication over wired media, wireless media and cellular to enable a plurality of functions 2 to 4, 5, 6. The operation can occur with or without supervision of an embedded processor 3.

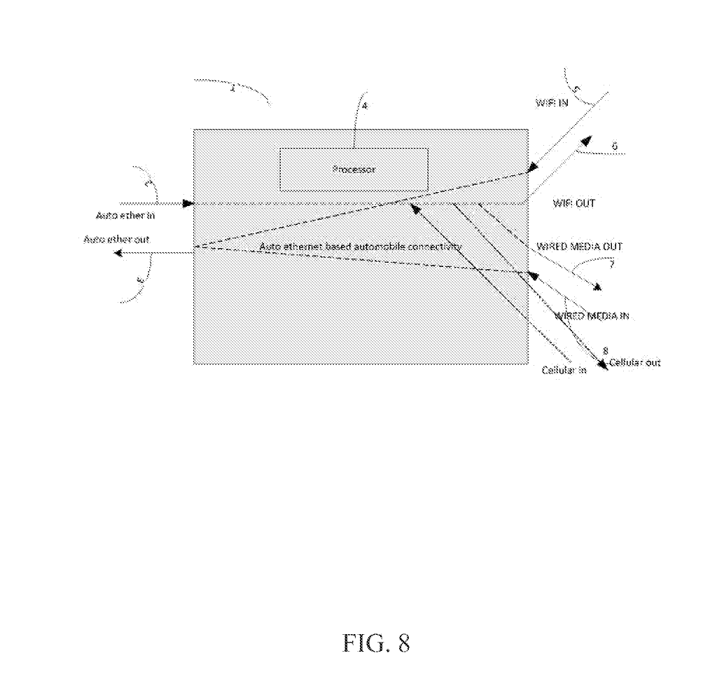

FIG. 8 illustrates the automobile Ethernet use case where the OBD port is replaced with an automobile Ethernet port 2, 3 for future to and from automobile connectivity to its various functions 5, 6, 7 and 8. In one embodiment, this includes entertainment, information, driver assistance and autonomous car electronic modules. With the cars getting increasingly connected, the number of automobile Ethernet nodes will grow. The function in one embodiment may involve the use of an embedded processor 4.

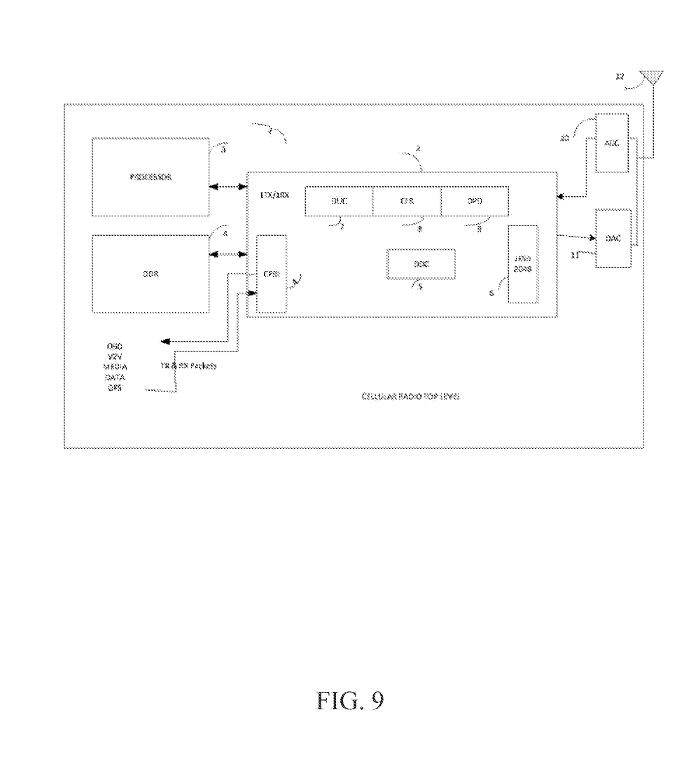

FIG. 9 illustrates a typical radio, physical interface and media access control pipe for a cellular interface 1. An antenna 12 is used to receive and transmit analog signals. In the receive direction, the analog information is converted into digital through an analog to digital converter 10, 11. The digital information is fed to DSP blocks like DDC (Digital Down Conversion 5) to perform an extraction of useful information from the demodulated signal. The useful information is further processed, if necessary with the help of an embedded processor 3 connected to memory 4. Packets are extracted and fed as DMA to the system memory for further processing and dissemination based on the application 5. In the transmit direction, the to be sent packets are processed for media readiness by performing a series of DSP steps (Digital Up Conversion 7, Crest Factor Reduction 8, Digital Pre Distortion 9) before being sent out to be converted into analog signal, transmitted with antenna 12. Though used in an exemplary way for cellular, all radio takes this form of processing though the range, quality and rate of information may be different.

In one embodiment, the present invention is targeted towards new cars where the owner does not buy the connectivity package from the dealer. The present invention is also targeted towards after market opportunity where the older cars may install the present invention for receipt of media and OBD information into the car and distributing it within the car for Bluetooth, WIFI and USB to other devices (cells phones, iPADs, laptops) of other passengers. In one embodiment, through these connections, the present invention will also provide a means to connect to the car's dashboard entertainment system. The cellular data pipe will be the uplink of a router built in, capable of providing a plurality of WIFI wireless connections and a plurality of wired Ethernet LAN connection. For both markets, the device will be installed, for example, behind the seat of the driver or passenger seat. Wires will run from the OBD port to this device, a LAN Ethernet cable will run from the device out, wires will run from the antenna to the coaxial ports for cellular, GPS connections as well as the WIFI and 802.11p connection. These wires will run from the interior of the car to the front or back, where the antennas will be placed outside of the car. A USB cable may optionally run from the dashboard outlet to the device, and if necessary and supported the audio/video ports may connect to various audio and video players in a wired way, including the dash board players.

In one embodiment, an integrated connected car device is provided. Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

In one embodiment, the configurable hardware images are stored for the embedded processor, WIFI, GPS, Cellular, V2V and other components separately over the cloud. These images are upgradable from the cloud by the user in a piece by piece way, over the air access to the internet. Where the automobile lasts for 7-10 years and these technologies evolve in a short period, the configurability of the hardware lets the automobile be updated with latest technology changes without any assistance from car maker dealer or services. In one embodiment, this implementation may comprise a complex programmable logic device. In another embodiment, it may comprise a single field programmable gate array or a plurality of such devices. While this exemplary embodiment is for an automobile, the invention equally applies to all movable things including cars, trucks, recreational vehicles and airplanes.

Consequently, embodiments as described herein may provide an integrated device in a connected car system that is able to provide data pipe connectivity more quickly and efficiently by utilizing multiple interfaces that communicate between each other. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. An integrated information handling automobile system, comprising:
a computer system with memory, peripherals, processor connected through buses and;
a plurality of wired and wireless interfaces of a plurality of power range and speeds and;
a first wireless interface connects the automobile electronics to internet;
a second wireless interface connects to a network in and around automobile;
a switching and routing mechanism between a plurality of wired and wireless interfaces.

2. The integrated information handling automobile system of claim 1 where at least one wired interface is the automobile's on board diagnostic port.

3. The integrated information handling automobile system of claim 1 where at least one wireless interface is a 2G/3G/4G or any next generation cellular interface.

4. The integrated information handling automobile system of claim 1 where at least one wired interface is an automobile Ethernet interface.

5. The integrated information handling automobile system of claim 1 where at least one wireless interface acts as an uplink for the router and at least one wireless interface acts as one of a plurality of ports of a router.

6. The integrated information handling automobile system of claim 1 where at least one wireless interface is a vehicle to vehicle or vehicle to infrastructure communication interface.

7. The integrated information handling automobile system of claim 1 where at least one electronic module is upgradable over the air.

8. An integrated information handling automobile device, comprising:
a computer system with memory, peripherals, processor connected through buses and;
a plurality of wired and wireless interfaces of a plurality of power range and speeds and;
a first wireless interface connects the automobile electronics to internet;
a second wireless interface connects to a network in and around automobile;
a switching and routing mechanism between a plurality of wired and wireless interfaces.

9. The integrated information handling automobile device of claim 8 where at least one wired interface is the automobile's on board diagnostic port.

10. The integrated information handling automobile device of claim 8 where at least one wireless interface is a 2G/3G/4G or any next generation cellular interface.

11. The integrated information handling automobile device of claim 8 where at least one wired interface is an automobile Ethernet interface.

12. The integrated information handling automobile device of claim 8 where at least one wireless interface acts as an uplink for the router and at least one wireless interface acts as one of a plurality of ports of a router.

13. The integrated information handling automobile device of claim 8 where at least one wireless interface is a vehicle to vehicle or vehicle to infrastructure communication interface.

14. The integrated information handling automobile device of claim 8 where at least one electronic module is upgradable over air.

15. A method for information handling in an automobile comprising:
receiving information over one of a plurality of wired and wireless interfaces;
processing and sending information over one of a plurality of wired and wireless interfaces.

16. The integrated information handling automobile method of claim 15 where at least one wired interface is the automobile's on board diagnostic port.

17. The integrated information handling automobile method of claim 15 where at least one wireless interface is a 2G/3G/4G or any next generation cellular interface.

18. The integrated information handling automobile method of claim 15 where at least one wired interface is an automobile Ethernet interface.

19. The integrated information handling automobile method of claim 15 where at least one wireless interface acts as an uplink for the router and at least one wireless interface acts as one of a plurality of ports of a router.

20. The integrated information handling automobile method of claim 15 where at least one electronic module is upgradable over air.

21. The integrated information handling automobile method of claim 14 where at least one wireless interface is a vehicle to vehicle or vehicle to infrastructure communication interface.
